(19) United States
(12) Patent Application Publication
(10) Pub. No.: US 2013/0077570 A1
(43) Pub. Date: Mar. 28, 2013

(54) APPARATUS AND METHOD FOR ACCESSING LOCAL NETWORK IN MOBILE COMMUNICATION SYSTEM SUPPORTING LOCAL NETWORK INTERNET PROTOCOL ACCESS SCHEME

(71) Applicant: CS CORPORATION, Seongnam-si (KR)

(72) Inventors: Dong-Chan LEE, Seongnam-si (KR); Jung-Suk LEE, Seongnam-si (KR); Hee-Joon PARK, Gwangju-si (KR); Ho-Sung YOON, Suwon-si (KR); Chan-Kyu KANG, Seoul (KR); Han-Jong JANG, Uiwang-si (KR); Seong-Ung YUN, Seongnam-si (KR); Hak-Yong LEE, Seongnam-si (KR); Kyoung-Jae LEE, Seoul (KR); Sang-Rok KIM, Busan (KR); Hyun-Seok LEE, Seoul (KR)

(73) Assignee: CS CORPORATION, Seongnam-si (KR)

(21) Appl. No.: 13/624,281

(22) Filed: Sep. 21, 2012

(30) Foreign Application Priority Data
Sep. 23, 2011 (KR) 10-2011-0096451

(51) Int. Cl. H04W 76/00

(52) U.S. Cl. 370/328

(57) ABSTRACT

An apparatus and method for accessing a local network in a mobile communication system supporting a Local Network Internet Protocol Access (LIPA) scheme are provided. In the method, a User Equipment (UE) transmits a radio bearer set up request packet to a router connected to a femto Node B in order to set up a radio bearer with the femto Node B, thereby the router converts the radio bearer set up request packet into a port forward radio bearer set up request packet using a port forward function, and transmits the port forward radio bearer set up request packet to the femto Node B.

### PRIORITY

This application claims the benefit under 35 U.S.C. §119(a) of a Korean Patent Application filed in the Korean Intellectual Property Office on Sep. 23, 2011 and assigned Serial No. 10-2011-0096451, the entire disclosure of which is incorporated herein by reference.

### BACKGROUND OF THE INVENTION

1. Field of the Invention

The present invention relates to an apparatus and method for accessing a local network in a mobile communication system supporting a Local network Internet Protocol Access (LIPA) scheme.

2. Description of the Related Art

A typical example of a mobile communication system may include a Wideband Code Division Multiple Access (WCMDA) communication system, and the WCDMA communication system has been evolved to provide various high-speed large-capacity services to User Equipments (UEs). Especially, in the WCDMA communication system, in order to increase an entire system capacity and improve a service quality, it is very important to provide a service in a shaded area(s), which contributes to an expansion of a service area of a Node B and an increase in capacity of the Node B.

Therefore, in the WCDMA communication system, various schemes of providing a service in a shaded area have been proposed, typical examples of which include a service scheme based on a relay or repeater using an interface with a macro Node B, and a service scheme based on a femto Node B using an interface with a core network. The femto Node B, which is the smallest Node B from among the Node Bs that have been proposed up to now, provides a communication service to a small number of UEs located in a femto cell area, which is a small-sized communication area, such as an office, a residence and a building, which are independent of the typical Node B, i.e., a macro Node B. In other words, the femto Node B not only can provide a communication service in a shaded area but also can reduce a load of the macro Node B. Therefore, the femto Node B may contribute to an increase in service capacity of service providers, unlike the relay that simply shares a capacity of the macro Node B.

The femto Node B interworks with an outer Internet Protocol (IP) network though a core network. However, it may result in data traffic load unnecessary for the core network that a UE connected to the femto Node B communicates through the core network upon accessing a local network geographically neighboring the femto Node B. So, a LIPA scheme as a scheme in which the UE connected to the femto Node B may directly communicate with a local host connected to the local network, not through the core network, upon accessing the local host connected to the local network has been proposed.

Upon moving to a macro cell, the UE connected to the femto Node B may not use the LIPA scheme. In this case, the UE may not access a local network, so it is impossible that the UE continuously communicates with a local host connected to the local network using the LIPA scheme.

The UE connected to the macro cell should release an old radio bearer which has set up in the femto Node B and set up a new radio bearer upon intending to again communicate with the local network. In this case, a user of the UE should go through several steps in order to set up the new radio bearer, so the user of the UE undergoes a hassle.

And, it results in a signaling load as well as the user's inconvenience that the UE sets up the new bearer thereby a total efficiency of resources becomes decreased in a mobile communication system.

### SUMMARY OF THE INVENTION

An aspect of an exemplary embodiment of the present invention is to provide an apparatus and method for accessing a local network in a mobile communication system supporting a LIPA scheme.

Another aspect of exemplary embodiments of the present invention is to provide a local network access apparatus and method for enabling to make an access to a local network regardless of a location of a UE in a mobile communication system supporting a LIPA scheme.

Further another aspect of exemplary embodiments of the present invention is to provide a local network access apparatus and method for automatically selecting a network path according to a location of a UE in a mobile communication system supporting a LIPA scheme.

In accordance with one aspect of the present invention, in a mobile communication system supporting a Local network Internet Protocol Access (LIPA) scheme, a User Equipment (UE) transmits a radio bearer set up request packet to a router connected to a femto Node B to set up a radio bearer with the femto Node B, thereby the router converts the radio bearer set up request packet into a port forward radio bearer set up request packet using a port forward function, and transmits the port forward radio bearer set up request packet to the femto Node B.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 schematically illustrates a WCMDA communication system in accordance with an exemplary embodiment of the present invention;

FIG. 2 schematically illustrates a radio bearer set up process between a UE connected to a macro Node B and a femto Node B in a WCDMA communication system according to an exemplary embodiment of the present invention;

FIG. 3 schematically illustrates a radio bearer set up process between a UE connected to a femto Node B and a femto Node B in a WCDMA communication system according to an exemplary embodiment of the present invention;

FIG. 4 schematically illustrates a process in which a UE connected to a macro Node B transmits a data packet to a local host in a WCDMA communication system according to an exemplary embodiment of the present invention;

FIG. 5 illustrates a format of an inner data packet in a WCDMA communication system according to an exemplary embodiment of the present invention;

FIG. 6 illustrates a format of an outer data packet in a WCDMA communication system according to an exemplary embodiment of the present invention;

FIG. 7 schematically illustrates a process in which a UE connected to a femto Node B transmits a data packet to a local host in a WCDMA communication system in accordance with an exemplary embodiment of the present invention;

FIG. 8 schematically illustrates a process in which a local host transmits a data packet to a UE connected to a macro Node B in a WCDMA communication system in accordance with an exemplary embodiment of the present invention;

FIG. 9 schematically illustrates a process in which a local host transmits a data packet to a UE connected to a femto Node B in a WCDMA communication system in accordance with an exemplary embodiment of the present invention;

FIG. 10 is a block diagram schematically illustrating an internal structure of a femto Node B in a WCDMA communication system in accordance with an exemplary embodiment of the present invention;

FIG. 11 is a block diagram schematically illustrating an internal structure of a UE in a WCDMA communication system in accordance with an exemplary embodiment of the present invention;

FIG. 12 is a block diagram schematically illustrating an internal structure of a router in a WCDMA communication system in accordance with an exemplary embodiment of the present invention.

Throughout the drawings, the same drawing reference numerals will be understood to refer to the same elements, features and structures.

### DETAILED DESCRIPTION OF EXEMPLARY EMBODIMENTS

Preferred embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

An exemplary embodiment of the present invention proposes an apparatus and method for accessing a local network in a mobile communication system supporting a Local network Internet Protocol Access (LIPA) scheme. Another exemplary embodiment of the present invention proposes a local network access apparatus and method for enabling to make an access to a local network regardless of a location of a User Equipment (UE) in a mobile communication system supporting a LIPA scheme. Further another exemplary embodiment of the present invention proposes a local network access apparatus and method for automatically selecting a network path according to location of a UE in a mobile communication system supporting a LIPA scheme.

For convenience, the following premises will be assumed.

(1) It will be assumed that a femto Node B and a UE know a public Internet Protocol (IP) address of a router in advance. It will be assumed that the public IP address of the router may be fixed or changed, so a server managing the public IP address of the router may be implemented if the public IP address of the router is changed, and the UE and the femto Node B may know the public IP address of the router by detecting the public IP address of the router from the server. And, it will be assumed that the server has a fixed IP address.

(2) It will be assumed that the femto Node B knows whether the UE is connected to the femto Node B in advance.

(3) It will be assumed that the UE may know the public IP address of the femto Node B by performing a prior join process with the femto Node B.

Exemplary embodiments of the present invention will be described below with reference to a mobile communication system, for example, a Wideband Code Division Multiple Access (WCDMA) communication system. However, it will be understood by those of ordinary skill in the art that the mobile communication system may be any one of a Code Division Multiple Access (CDMA) communication system, a 3rd Generation Partnership Project Long-Term Evolution (3GPP LTE) communication system, an Institute of Electrical and Electronics Engineers (IEEE) 802.16 communication system, and Mobile Worldwide Interoperability for Microwave Access (Mobile WiMAX) communication system as well as the WCDMA communication system.

In an embodiment of the invention, there is provided a method for accessing a local network by a User Equipment (UE) in a mobile communication system supporting a Local network Internet Protocol Access (LIPA) scheme, comprising: if a data packet targeting a local host occurs, converting the first inner data packet into the first outer data packet by performing an encapsulation process; and transmitting the first outer data packet to a femto Node B through a router thereby the femto Node B converts the second outer data packet into the second inner data packet by performing a decapsulation process, and transmits the second inner data packet to the local host, wherein each of the first inner data packet and the second inner data packet is a data packet used in a local network, each of the first outer data packet and the second outer data packet is a data packet used in an outer network, and the second outer data packet is an outer data packet into which the router converts the first outer data packet using a port forward function.

In an embodiment of the invention, each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

In an embodiment of the invention, a field value of an inner source IP address field included in the first inner data packet is set as a Gateway GPRS Support Node (GGSN) IP address of the UE, a field value of an inner destination IP address field is set as a local IP address of the local host, a field value of an outer source IP address field included in the first outer data packet is set as a public IP address of the router, a field value of an outer destination IP address field is set as the GGSN IP address of the UE, a field value of the port field is set as a global data plan port, a field value of an outer source IP address field included in the second outer data packet is set equal to the field value of an outer source IP address field included in the first outer data packet, a field value of an outer destination IP address field is set as a local IP address of the femto Node B, a field value of the port field is set as a local data plan port, a field value of an inner source IP address field included in the second inner data packet is set as a local IP address mapped to a GGSN IP address of the UE, and a field value of an inner destination IP address field is set equal to the field value of an inner destination IP address field included in the first inner data packet.

In an embodiment of the invention, the UE is connected to one of a macro Node B and the femto Node B.

In an embodiment of the invention, there is provided a method for supporting an access to a local network of a User Equipment (UE) by a femto Node B in a mobile communication system supporting a Local network Internet Protocol Access (LIPA) scheme, comprising: receiving the second outer data packet into which a router has converted the first outer data packet using a port forward function from the router; converting the second outer data packet into the first inner data packet by performing a decapsulation process; and transmitting the first inner data packet to a local host, wherein the first outer data packet is generated by performing an encapsulation process on the second inner data packet which is generated if a data packet targeting the UE occurs, each of the first inner data packet and the second inner data packet is a data packet used in a local network, and each of the first outer data packet and the second outer data packet is a data packet used in an outer network.

In an embodiment of the invention, each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

In an embodiment of the invention, a field value of an inner source IP address field included in the first inner data packet is set as a Gateway GPRS Support Node (GGSN) IP address of the UE, a field value of an inner destination IP address field is set as a local IP address of the local host, a field value of an outer source IP address field included in the first outer data packet is set as a public IP address of the router, a field value of an outer destination IP address field is set as the GGSN IP address of the UE, a field value of the port field is set as a global data plan port, a field value of an outer source IP address field included in the second outer data packet is set equal to the field value of an outer source IP address field included in the first outer data packet, a field value of an outer destination IP address field is set as a local IP address of the femto Node B, a field value of the port field is set as a local data plan port, a field value of an inner source IP address field included in the second inner data packet is set as a local IP address mapped to a GGSN IP address of the UE, and a field value of an inner destination IP address field is set equal to the field value of an inner destination IP address field included in the first inner data packet.

In an embodiment of the invention, the UE is connected to one of a macro Node B and the femto Node B.

In an embodiment of the invention, there is provided a method for accessing a local network by a User Equipment (UE) in a mobile communication system supporting a Local network Internet Protocol Access (LIPA) scheme, comprising: receiving the second outer data packet into which a router has converted the first outer data packet received from a femto Node B using a port forward function from the router; and converting the second outer data packet into the first inner data packet by performing a decapsulation process, wherein the first outer data packet is generated by the femto Node B by performing an encapsulation process on the second inner data packet which is generated if a data packet targeting the UE occurs at a local host, each of the first inner data packet and the second inner data packet is a data packet used in the local network, and each of the first outer data packet and the second outer data packet is a data packet used in an outer network.

In an embodiment of the invention, each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

In an embodiment of the invention, a field value of an inner source IP address field included in the second inner data packet is set as a local IP address of the local host, a field value of an inner destination IP address field is set as a Gateway GPRS Support Node (GGSN) IP address of the UE, a field value of an outer source IP address field included in the first outer data packet is set as a local IP address of the femto Node B, a field value of an outer destination IP address field is set as the GGSN IP address of the UE, a field value of the port field is set as a local data plan port, a field value of an outer source IP address field included in the second outer data packet is set as a public IP address of the router, a field value of an outer destination IP address field is set equal to an outer destination IP address included in the first outer data packet, a field value of the port field is set as a global data plan port, a field value of an inner source IP address field and a field value of an inner destination IP address field included in the first inner data packet are set equal to a field value of an inner source IP address field and a field value of an inner destination IP address field included in the second inner data packet respectively.

In an embodiment of the invention, the UE is connected to one of a macro Node B and the femto Node B.

In an embodiment of the invention, there is provided a method for method for supporting an access to a local network of a User Equipment (UE) by a femto Node B in a mobile communication system supporting a Local network Internet Protocol Access (LIPA) scheme, comprising: receiving the second outer data packet into which a router has converted the first outer data packet using a port forward function from the router; converting the second outer data packet into the first inner data packet by performing a decapsulation process; and transmitting the first inner data packet to a UE, wherein the outer data packet is generated by the femto Node B by performing an encapsulation process on the second inner data packet which is generated if a data packet targeting the UE occurs at a local host, each of the first inner data packet and the second inner data packet is a data packet used in the local network, and each of the first outer data packet and the second outer data packet is a data packet used in an outer network.

In an embodiment of the invention, each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

In an embodiment of the invention, In an embodiment of the invention, a field value of an inner source IP address field included in the second inner data packet is set as a local IP address of the local host, a field value of an inner destination IP address field is set as a Gateway GPRS Support Node (GGSN) IP address of the UE, a field value of an outer source IP address field included in the first outer data packet is set as a local IP address of the femto Node B, a field value of an outer destination IP address field is set as the GGSN IP address of the UE, a field value of the port field is set as a local data plan port, a field value of an outer source IP address field included in the second outer data packet is set as a public IP address of the router, a field value of an outer destination IP address field is set equal to an outer destination IP address included in the first outer data packet, a field value of the port field is set as a global data plan port, a field value of an inner source IP address field and a field value of an inner destination IP address field included in the first inner data packet are set equal to a field value of an inner source IP address field and a field value of an inner destination IP address field included in the second inner data packet respectively.

In an embodiment of the invention, the UE is connected to one of a macro Node B and the femto Node B.

In an embodiment of the invention, there is provided a method for accessing a local network by a User Equipment (UE) in a mobile communication system supporting a Local network Internet Protocol Access (LIPA) scheme, comprising: receiving an outer data packet which a router receives from a femto Node B from the router; and converting the outer data packet into the first inner data packet by performing a decapsulation process, wherein the outer data packet is generated by the femto Node B by performing an encapsulation process on the second inner data packet which is generated if a data packet targeting the UE occurs at a local host, each of the first inner data packet and the second inner data packet is a data packet used in a local network, and the outer data packet is a data packet used in an outer network.

In an embodiment of the invention, each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and the outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

In an embodiment of the invention, a field value of an inner source IP address field included in the second inner data packet is set as a local IP address of the local host, a field value of an inner destination IP address field is set as a Gateway GPRS Support Node (GGSN) IP address of the UE, a field value of an outer source IP address field included in the outer data packet is set as a local IP address of the femto Node B, a field value of an outer destination IP address field is set as the GGSN IP address of the UE, a field value of the port field is set as a local data plan port, a field value of an inner source IP address field and a field value of an inner destination IP address field included in the first inner data packet are set equal to a field value of an inner source IP address field and a field value of an inner destination IP address field included in the second inner data packet respectively.

In an embodiment of the invention, the UE is connected to one of a macro Node B and the femto Node B.

In an embodiment of the invention, there is provided a method for supporting an access to a local network of a User Equipment (UE) by a femto Node B in a mobile communication system supporting a Local network Internet Protocol Access (LIPA) scheme, comprising: receiving an outer data packet from a router; converting the outer data packet into the first inner data packet by performing a decapsulation process; and transmitting the first inner data packet to a UE, wherein the outer data packet is generated by the femto Node B by performing an encapsulation process on the second inner data packet which is generated if a data packet targeting the UE occurs at a local host, each of the first inner data packet and the second inner data packet is a data packet used in a local network, and the outer data packet is a data packet used in an outer network.

In an embodiment of the invention, each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and the outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

In an embodiment of the invention, a field value of an inner source IP address field included in the second inner data packet is set as a local IP address of the local host, a field value of an inner destination IP address field is set as a Gateway GPRS Support Node (GGSN) IP address of the UE, a field value of an outer source IP address field included in the outer data packet is set as a local IP address of the femto Node B, a field value of an outer destination IP address field is set as the GGSN IP address of the UE, a field value of the port field is set as a local data plan port, a field value of an inner source IP address field and a field value of an inner destination IP address field included in the first inner data packet are set equal to a field value of an inner source IP address field and a field value of an inner destination IP address field included in the second inner data packet respectively.

In an embodiment of the invention, the UE is connected to one of a macro Node B and the femto Node B.

In an embodiment of the invention, there is provided a User Equipment (UE) in a mobile communication system supporting a Local network Internet Protocol Access (LIPA) scheme, comprising: a controller for converting the first inner data packet into the first outer data packet by performing an encapsulation process if a data packet targeting a local host occurs; and a transmitter for transmitting the first outer data packet to a femto Node B through a router thereby the femto Node B converts the second outer data packet into the second inner data packet by performing a decapsulation process, and transmits the second inner data packet to the local host, wherein each of the first inner data packet and the second inner data packet is a data packet used in a local network, each of the first outer data packet and the second outer data packet is a data packet used in an outer network, and the second outer data packet is an outer data packet into which the router converts the first outer data packet using a port forward function.

In an embodiment of the invention, each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

In an embodiment of the invention, a field value of an inner source IP address field included in the first inner data packet is set as a Gateway GPRS Support Node (GGSN) IP address of the UE, a field value of an inner destination IP address field is set as a local IP address of the local host, a field value of an outer source IP address field included in the first outer data packet is set as a public IP address of the router, a field value of an outer destination IP address field is set as the GGSN IP address of the UE, a field value of the port field is set as a global data plan port, a field value of an outer source IP address field included in the second outer data packet is set equal to the field value of an outer source IP address field included in the first outer data packet, a field value of an outer destination IP address field is set as a local IP address of the femto Node B, a field value of the port field is set as a local data plan port, a field value of an inner source IP address field included in the second inner data packet is set as a local IP address mapped to a GGSN IP address of the UE, and a field value of an inner destination IP address field is set equal to the field value of an inner destination IP address field included in the first inner data packet.

In an embodiment of the invention, the UE is connected to one of a macro Node B and the femto Node B.

In an embodiment of the invention, there is provided a femto Node B in a mobile communication system supporting a Local network Internet Protocol Access (LIPA) scheme, comprising: a receiver for receiving the second outer data packet into which a router has converted the first outer data packet using a port forward function from the router; a controller for converting the second outer data packet into the first inner data packet by performing a decapsulation process; and a transmitter for transmitting the first inner data packet to a local host, wherein the first outer data packet is generated by performing an encapsulation process on the second inner data packet which is generated if a data packet targeting the UE occurs, each of the first inner data packet and the second inner data packet is a data packet used in a local network, and each of the first outer data packet and the second outer data packet is a data packet used in an outer network.

In an embodiment of the invention, each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

In an embodiment of the invention, a field value of an inner source IP address field included in the first inner data packet is set as a Gateway GPRS Support Node (GGSN) IP address of the UE, a field value of an inner destination IP address field is set as a local IP address of the local host, a field value of an outer source IP address field included in the first outer data packet is set as a public IP address of the router, a field value of an outer destination IP address field is set as the GGSN IP address of the UE, a field value of the port field is set as a global data plan port, a field value of an outer source IP address field included in the second outer data packet is set equal to the field value of an outer source IP address field included in the first outer data packet, a field value of an outer destination IP address field is set as a local IP address of the femto Node B, a field value of the port field is set as a local data plan port, a field value of an inner source IP address field included in the second inner data packet is set as a local IP address mapped to a GGSN IP address of the UE, and a field value of an inner destination IP address field is set equal to the field value of an inner destination IP address field included in the first inner data packet.

In an embodiment of the invention, the UE is connected to one of a macro Node B and the femto Node B.

In an embodiment of the invention, there is provided a User Equipment (UE) in a mobile communication system supporting a Local network Internet Protocol Access (LIPA) scheme, comprising: a receiver for receiving the second outer data packet into which a router has converted the first outer data packet received from a femto Node B using a port forward function from the router; and a controller for converting the second outer data packet into the first inner data packet by performing a decapsulation process, wherein the first outer data packet is generated by the femto Node B by performing an encapsulation process on the second inner data packet which is generated if a data packet targeting the UE occurs at a local host, each of the first inner data packet and the second inner data packet is a data packet used in the local network, and each of the first outer data packet and the second outer data packet is a data packet used in an outer network.

In an embodiment of the invention, each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

In an embodiment of the invention, a field value of an inner source IP address field included in the second inner data packet is set as a local IP address of the local host, a field value of an inner destination IP address field is set as a Gateway GPRS Support Node (GGSN) IP address of the UE, a field value of an outer source IP address field included in the first outer data packet is set as a local IP address of the femto Node B, a field value of an outer destination IP address field is set as the GGSN IP address of the UE, a field value of the port field is set as a local data plan port, a field value of an outer source IP address field included in the second outer data packet is set as a public IP address of the router, a field value of an outer destination IP address field is set equal to an outer destination IP address included in the first outer data packet, a field value of the port field is set as a global data plan port, a field value of an inner source IP address field and a field value of an inner destination IP address field included in the first inner data packet are set equal to a field value of an inner source IP address field and a field value of an inner destination IP address field included in the second inner data packet respectively.

In an embodiment of the invention, the UE is connected to one of a macro Node B and the femto Node B.

In an embodiment of the invention, there is provided a femto Node B in a mobile communication system supporting a Local network Internet Protocol Access (LIPA) scheme, comprising: a receiver for receiving the second outer data packet into which a router ha converted the first outer data packet using a port forward function from the router; a controller for converting the second outer data packet into the first inner data packet by performing a decapsulation process; and a transmitter for transmitting the first inner data packet to a User Equipment (UE), wherein the first outer data packet is generated by the femto Node B by performing an encapsulation process on the second inner data packet which is generated if a data packet targeting the UE occurs at a local host, each of the first inner data packet and the second inner data packet is a data packet used in a local network, and each of the first outer data packet and the second outer data packet is a data packet used in an outer network.

In an embodiment of the invention, each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

In an embodiment of the invention, In an embodiment of the invention, a field value of an inner source IP address field included in the second inner data packet is set as a local IP address of the local host, a field value of an inner destination IP address field is set as a Gateway GPRS Support Node (GGSN) IP address of the UE, a field value of an outer source IP address field included in the first outer data packet is set as a local IP address of the femto Node B, a field value of an outer destination IP address field is set as the GGSN IP address of the UE, a field value of the port field is set as a local data plan port, a field value of an outer source IP address field included in the second outer data packet is set as a public IP address of the router, a field value of an outer destination IP address field is set equal to an outer destination IP address included in the first outer data packet, a field value of the port field is set as a global data plan port, a field value of an inner source IP address field and a field value of an inner destination IP address field included in the first inner data packet are set equal to a field value of an inner source IP address field and a field value of an inner destination IP address field included in the second inner data packet respectively.

In an embodiment of the invention, the UE is connected to one of a macro Node B and the femto Node B.

In an embodiment of the invention, there is provided a User Equipment (UE) in a mobile communication system supporting a Local network Internet Protocol Access (LIPA) scheme, comprising: a receiver for receiving an outer data packet which a router receives from a femto Node B from the router; and a controller for converting the outer data packet into the first inner data packet by performing a decapsulation process, wherein the first outer data packet is generated by the femto Node B by performing an encapsulation process on the second inner data packet which is generated if a data packet targeting the UE occurs at a local host, each of the first inner data packet and the second inner data packet is a data packet used in a local network, and the outer data packet is a data packet used in an outer network.

In an embodiment of the invention, each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and the outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

In an embodiment of the invention, a field value of an inner source IP address field included in the second inner data packet is set as a local IP address of the local host, a field value of an inner destination IP address field is set as a Gateway GPRS Support Node (GGSN) IP address of the UE, a field value of an outer source IP address field included in the outer data packet is set as a local IP address of the femto Node B, a field value of an outer destination IP address field is set as the GGSN IP address of the UE, a field value of the port field is set as a local data plan port, a field value of an inner source IP address field and a field value of an inner destination IP address field included in the first inner data packet are set equal to a field value of an inner source IP address field and a field value of an inner destination IP address field included in the second inner data packet respectively.

In an embodiment of the invention, the UE is connected to one of a macro Node B and the femto Node B.

In an embodiment of the invention, there is provided a femto Node B in a mobile communication system supporting a Local network Internet Protocol Access (LIPA) scheme, comprising: a receiver for receiving an outer data packet from a router; a controller for converting the outer data packet into the first inner data packet by performing a decapsulation process; and a transmitter for transmitting the first inner data packet to a UE, wherein the first outer data packet is generated by the femto Node B by performing an encapsulation process on the second inner data packet which is generated if a data packet targeting the UE occurs at a local host, each of the first inner data packet and the second inner data packet is a data packet used in a local network, and the outer data packet is a data packet used in an outer network.

In an embodiment of the invention, each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and the outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

In an embodiment of the invention, a field value of an inner source IP address field included in the second inner data packet is set as a local IP address of the local host, a field value of an inner destination IP address field is set as a Gateway GPRS Support Node (GGSN) IP address of the UE, a field value of an outer source IP address field included in the outer data packet is set as a local IP address of the femto Node B, a field value of an outer destination IP address field is set as the GGSN IP address of the UE, a field value of the port field is set as a local data plan port, a field value of an inner source IP address field and a field value of an inner destination IP address field included in the first inner data packet are set equal to a field value of an inner source IP address field and a field value of an inner destination IP address field included in the second inner data packet respectively.

In an embodiment of the invention, the UE is connected to one of a macro Node B and the femto Node B.

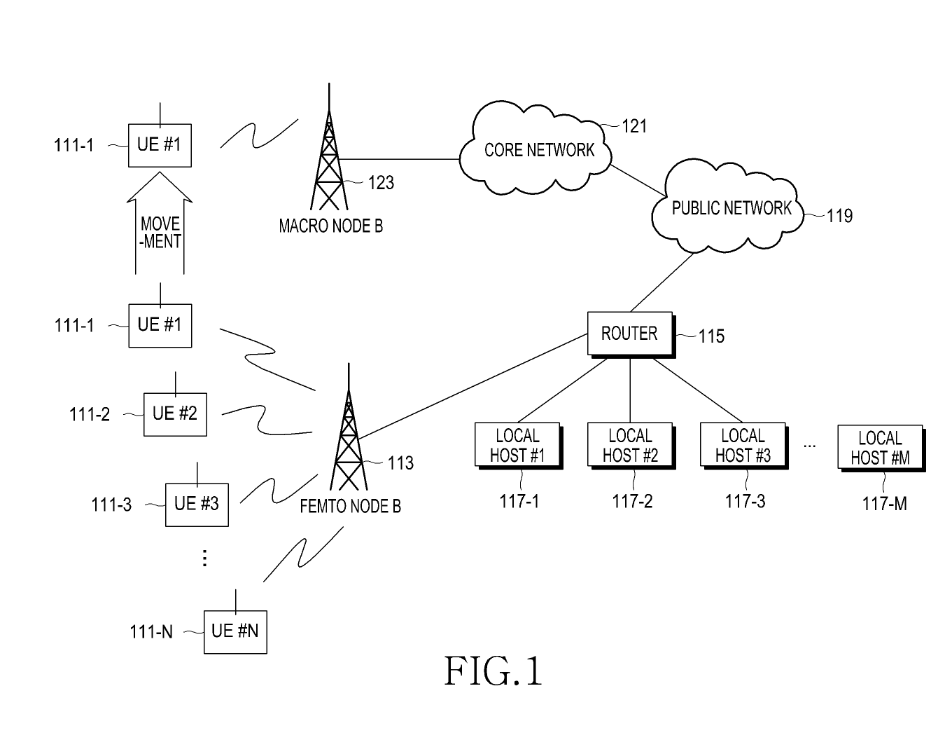

FIG. 1 schematically illustrates a WCMDA communication system in accordance with an exemplary embodiment of the present invention.

Referring to FIG. 1, the WCDMA communication system includes a plurality of UEs, for example, N UEs, i.e., an UE#1 111-1, an UE#2 111-2, an UE#3 111-3, . . . , and an UE#N 111-N, a femto Node B 113, a router 115, a plurality of local hosts, for example, M local hosts, i.e., a local host #1 117-1, a local host #2 117-2, a local host #3 117-3, . . . , and a local host #M 117-M, a public network 119, a core network 121, and a macro Node B 123.

In FIG. 1, the public network 119 is connected to one router, i.e., the router 115, and one router is connected to one femto Node B, i.e., the femto Node B 113. However, it will be understood by those of ordinary skill in the art that the number of routers which are connected to one public network and the number of femto Node Bs which are connected to one femto Node B are not limited.

In FIG. 1, it will be assumed that the WCMDA communication system supports a LIPA scheme. While the UEs and the femto Node B 113 are distinguished from local hosts in FIG. 1, it is to be understood that this is for merely convenience of description. In other words, the UEs and the femto Node B 113 are also local hosts in view of the router 115 if the WCMDA communication system uses the LIPA scheme.

In the WCDMA communication system, if a LIPA scheme, which has been proposed up to now, is used, an arbitrary UE among UEs connected to the femto Node B 113, for example, a UE#1 111-1 may not use the LIPA scheme if the UE#1 111-1 is connected to the macro Node B 123 by moving to a macro cell different from a cell managed by the femto Node B 113, i.e., a femto cell. Here, the macro cell represents a cell managed by the macro Node B 123. In the case that the UE#1 111-1 may not use the LIPA scheme, it is impossible for the UE#1 111-1 to access a local network. So, the UE#1 111-1 may not communicate with local hosts connected to the local network using the LIPA scheme.

Therefore, exemplary embodiments of the present invention propose an apparatus and method for enabling to access a local network even if a UE connected to a femto Node B is connected to a macro Node B. In other words, exemplary embodiments of the present invention propose an apparatus and method for enabling to access a local network even if the UE#1 111-1 connected to the femto Node B 113 is connected to the macro Node B 123.

Further, exemplary embodiments of the present invention propose a local network access apparatus and method for automatically performing a network path selection according to a location of a UE. In other words, exemplary embodiments of the present invention propose an apparatus and method for automatically performing a network path selection by considering a case that the UE#1 111-1 is connected to the femto Node B 113 and a case that the UE#1 111-1 is connected to the macro Node B 123.

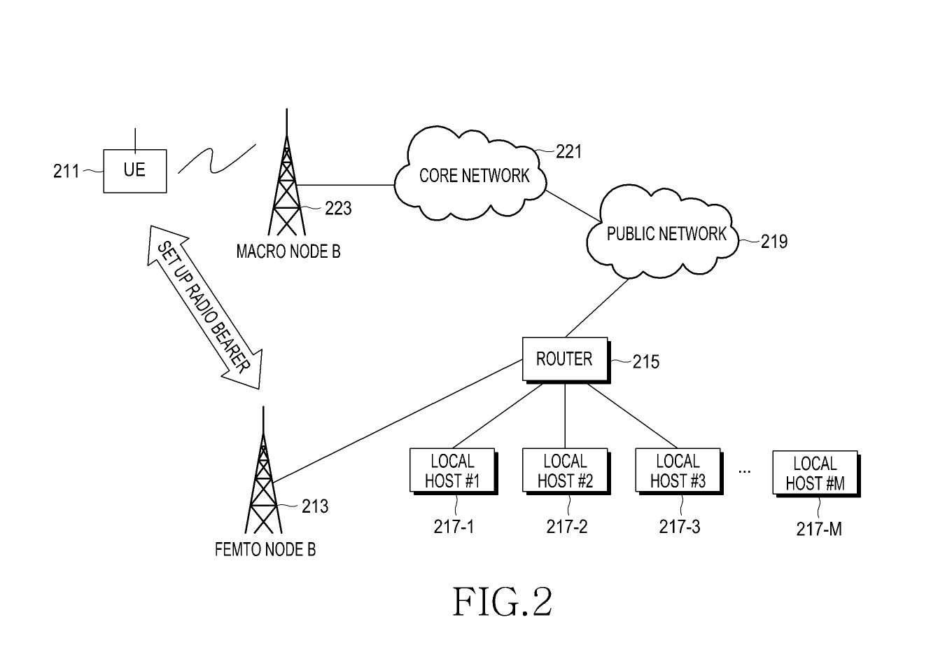

FIG. 2 schematically illustrates a radio bearer set up process between a UE connected to a macro Node B and a femto Node B in a WCDMA communication system according to an exemplary embodiment of the present invention.

Referring to FIG. 2, it will be assumed that a UE 211 connected to a macro Node B 223 knows a public IP address of a femto Node B 213 and a public IP address of a router 215. That is, it will be assumed that the UE 211 knows in advance the public IP address of the femto Node B 213 and the public IP address of the router 215 by performing a join process with the femto Node B 213.

The UE 211 transmits a radio bearer set up request packet to the router 215 through the macro Node B 223, a core network 221, and a public network 219 in order to set up a radio bearer with the femto Node B 213. The radio bearer set up request packet includes a destination IP address field, a source IP address field, and a port field. A field value of the destination IP address field is set as a public IP address of the router 215, a field value of the source IP address field is set as a Gateway GPRS Support Node (GGSN) IP address of the UE 211, and a field value of the port field is set as a global control plane port. Hereinafter, for convenience, a radio bearer set up request packet transmitted from a UE to a router will be referred as a UE-router radio bearer set up request packet.

Upon receiving the UE-router radio bearer set up request packet, the router 215 converts the UE-router radio bearer set up request packet into a router-femto Node B radio bearer set up request packet using a port forward scheme, and transmits the router-femto Node B radio bearer set up request packet to the femto Node B 213. The router-femto Node B radio bearer set up request packet represents a radio bearer set up request packet transmitted from a router to a femto Node B, and includes a destination IP address field, a source IP address field, and a port field.

As the field value of the port field included in the UE-router radio bearer set up request packet is the global control plane port, the router 215 sets a field value of the destination IP address field included in the router-femto Node B radio bearer set up request packet as an IP address of the femto Node B 213, and sets a field value of the port field included in the router-femto Node B radio bearer set up request packet as a local control plane port. A field value of the source IP address field included in the router-femto Node B radio bearer set up request packet is sets as a GGSN IP address of the UE 211, equal to the field value of the source IP address field included in the UE-router radio bearer set up request packet.

The femto Node B 213 receives the router-femto Node B radio bearer set up request packet from the router 215, and generates a LIPA table by allocating a local IP address to the GGSN IP address of the UE 211, as the source IP address included in the router-femto Node B radio bearer set up request packet because the field value of the port field included in the router-femto Node B radio bearer set up request packet is the local control plane port. It is of course that the femto Node B 213 may allocate the local IP address to the GGSN IP address of the UE 211 and manage the local IP address by updating a LIPA table generated in advance, not generating the LIPA table if there is the LIPA table which the femto Node B 213 manages.

As described above, the LIPA table in which the local IP address of the UE 211 is mapped to the GGSN IP address of the UE 211 is generated in the femto Node B 213, so a radio bearer between the UE 211 connected to the macro Node B 223 and the femto Node B 213 is set up.

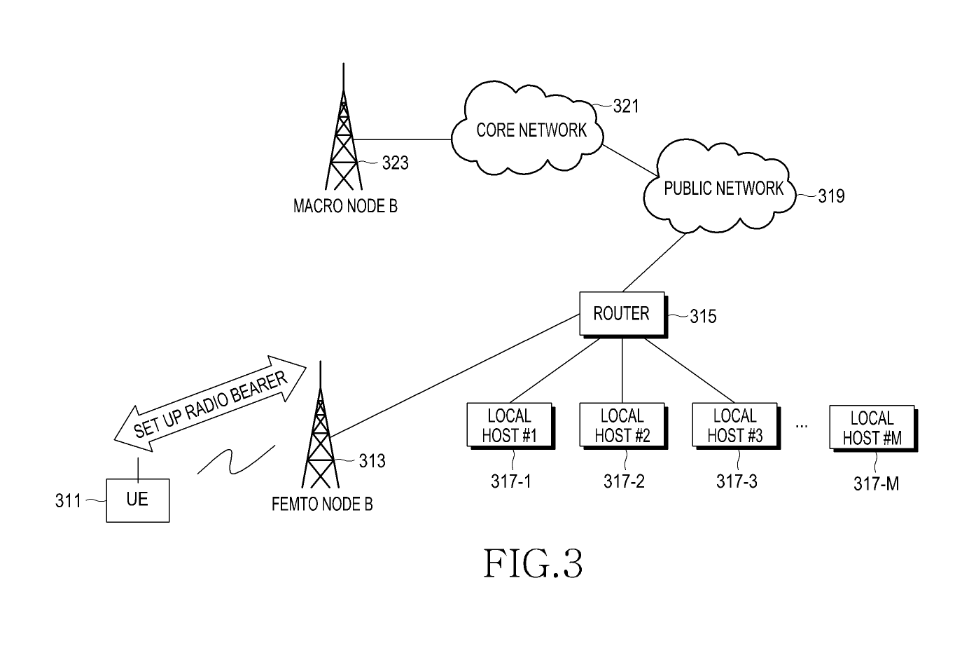

FIG. 3 schematically illustrates a radio bearer set up process between a UE connected to a femto Node B and a femto Node B in a WCDMA communication system according to an exemplary embodiment of the present invention.

Referring to FIG. 3, it will be assumed that a UE 311 connected to a femto Node B 313 knows a public IP address of a femto Node B 313 and a public IP address of a router 315. That is, it will be assumed that the UE 311 knows the public IP address of the femto Node B 313 and the public IP address of the router 315 by performing a join process with the femto Node B 313.

The UE 311 transmits a UE-femto Node B radio bearer set up request packet to the router 315 through the femto Node B 313 in order to set up a radio bearer with the femto Node B 313. The UE-femto Node B radio bearer set up request packet represents a radio bearer set up request packet transmitted from a UE to a femto Node B. The UE-femto Node B radio bearer set up request packet includes a destination IP address field, a source IP address field, and a port field. A field value of the destination IP address field is set as a public IP address of the router 315, a field value of the source IP address field is set as a GGSN IP address of the UE 311, and a field value of the port field is set as a global control plane port.

Upon receiving the UE-femto Node B radio bearer set up request packet, the router 315 converts the UE-femto Node B radio bearer set up request packet into a router-femto Node B radio bearer set up request packet using a port forward scheme, and transmits the router-femto Node B radio bearer set up request packet to the femto Node B 313. The router-femto Node B radio bearer set up request packet includes a destination IP address field, a source IP address field, and a port field. A field value of the destination IP address field is set as a local IP address of the femto Node B 313, a field value of the source IP address field is set as a GGSN IP address of the UE 311, and a field value of the port field is set as a local control plane port. The router-femto Node B radio bearer set up request packet represents a radio bearer set up request packet transmitted from a router to a femto Node B.

The femto Node B 313 receives the router-femto Node B radio bearer set up request packet, and generates a LIPA table by allocating a local IP address to the GGSN IP address of the UE 311, as the source IP address included in the router-femto Node B radio bearer set up request packet because the field value of the port field included in the router-femto Node B radio bearer set up request packet is the local control plane port. It is of course that the femto Node B 313 may allocate the local IP address to the GGSN IP address of the UE 311 and manage the local IP address by updating a LIPA table generated, not generating the LIPA table if there is the LIPA table which the femto Node B 313 manages.

As described above, the LIPA table in which the local IP address of the UE 311 is mapped to the GGSN IP address of the UE 311 is generated in the femto Node B 313, so a radio bearer between the UE 311 connected to the femto Node B 313 and the femto Node B 313 is set up.

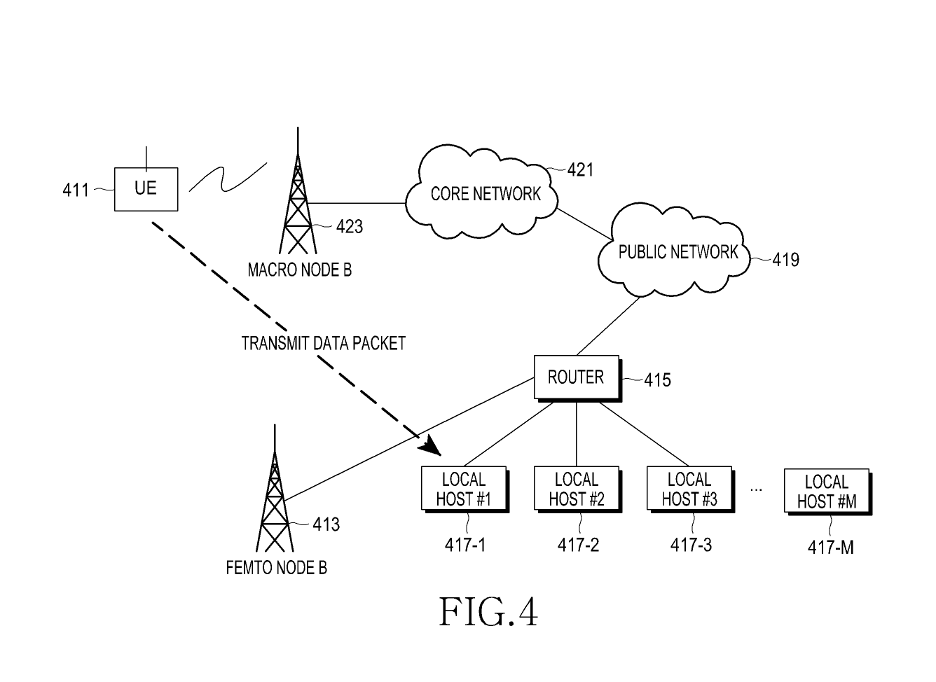

FIG. 4 schematically illustrates a process in which a UE connected to a macro Node B transmits a data packet to a local host in a WCDMA communication system according to an exemplary embodiment of the present invention.

Referring to FIG. 4, if a data packet targeting a local host#1 417-1 occurs, a UE 411 connected to a macro Node B 423 converts an inner data packet into an outer data packet by performing an encapsulation process, and transmits the outer data packet to a router 415 through a public network 419.

A description of formats of the inner data packet and the outer data packet will be followed.

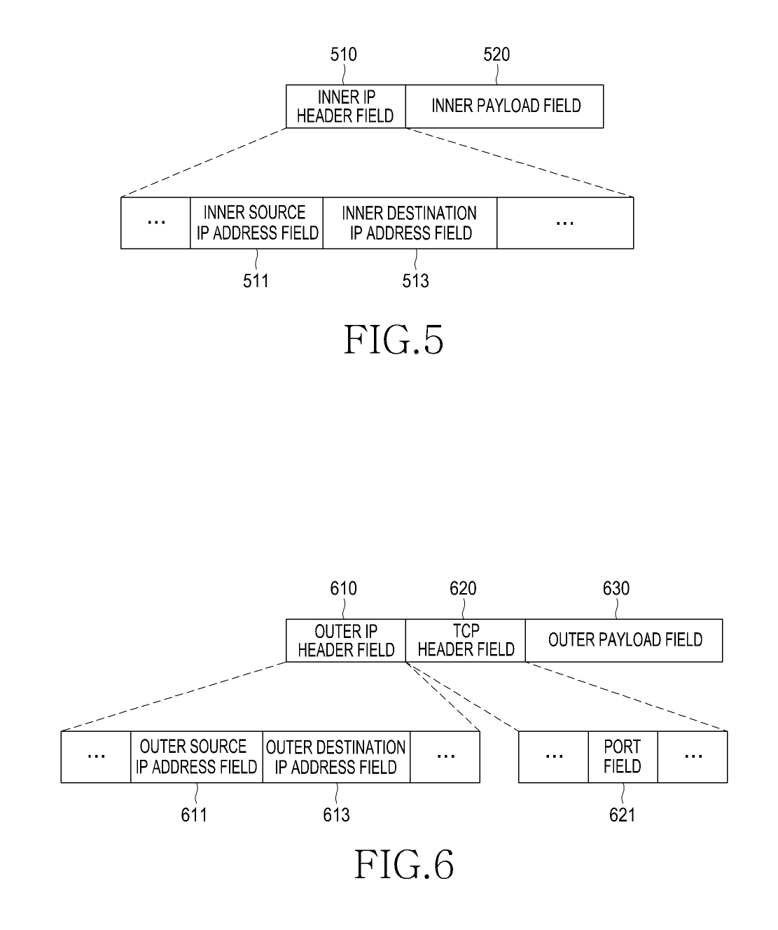

FIG. 5 illustrates a format of an inner data packet in a WCDMA communication system according to an exemplary embodiment of the present invention.

Referring to FIG. 5, an inner data packet includes an inner IP header field 510, and an inner payload field 520. The inner data packet represents a data packet used in a local network, and may be converted into an outer data packet through an encapsulation process. The encapsulation process will be described below.

The inner IP header field 510 includes an inner source IP address field 511 and an inner destination IP address field 513. A field value of the inner source IP address field 511 is set as an IP address, of a source entity, used in a local network, and a field value of the inner destination IP address field 513 is set as an IP address, of a destination entity, used in the local network.

FIG. 6 illustrates a format of an outer data packet in a WCDMA communication system according to an exemplary embodiment of the present invention.

Referring to FIG. 6, an outer data packet includes an outer IP header field 610, a Transmission Control Protocol (TCP) header field 620, and an outer payload field 630. The outer data packet represents a data packet used in an outer network, and may be converted into an inner data packet through a decapsulation process. The decapsulation process will be described below.

The outer IP header field 610 includes an outer source IP address field 611 and an outer destination IP address field 613. A field value of the outer source IP address field 611 is set as an IP address, of a source entity, used in an outer network, and a field value of the outer destination IP address field 613 is set as an IP address, of a destination entity, used in the outer network.

The TCP header field 620 includes a port field 621, and a field value of the port field 621 is set as one of a global data plane port and a local data plane port. The outer payload field 630 has a structure equal to a structure of an inner data packet as described in FIG. 5, so the detailed description of the outer payload field 630 will be omitted.

Meanwhile, in FIG. 4, if a data packet targeting a local host #1 417-1 occurs, a UE 411 converts the data packet, i.e., an inner data packet into an outer data packet by performing an encapsulation process. A detailed description of this operation will be followed.

First, the UE 411 generates an inner data packet by setting a field value of an inner source IP address field included in an inner IP header field as a GGSN IP address of the UE 411, setting a field value of an inner destination IP address field as a local IP address of the local host #1 417-1, and setting a field value of an inner payload field as data intended to be transmitted to the local host #1 417-1.

The UE 411 converts the inner data packet into an outer data packet by performing an encapsulation process. The encapsulation process represents a process converting an inner data packet into an outer packet. In other words, the UE 411 generates an outer data packet by setting a field value of an outer destination IP address field as a public IP address of a router 415, setting a field value of an outer source IP address field as a GGSN IP address of the UE 411, setting a field value of a port field as a global data plane port, and setting a field value of an outer payload field as equal to the inner data packet.

The outer data packet which is generated using the encapsulation process is transmitted to the router 415. The router 415 converts the field value of the outer destination IP address field into a local IP address of a femto Node B 413 using a port forward function, converts the field value of the port field into a local data plane port, and transmits, to the femto Node B 413, the outer data packet with the converted field value of the outer destination IP address field and the converted field value of the port field.

The femto Node B 413 converts the outer data packet into an inner data packet by performing a decapsulation process on the outer data packet because a field value of the outer data packet received from the router 415 is the local data plan port. The decapsulation process is a process converting an outer data packet into an inner data packet. That is, a field value of a port field included in the outer data packet is a local data plan port, so the femto Node B generates the inner data packet by setting a field value of an inner source IP address field included in a payload field included in the outer data packet as a local IP address mapped to a GGSN IP address of the UE 411 in an LIPA table managed by the femto Node B.

The femto Node B 413 transmits the generated inner data packet to the local host #1 417-1.

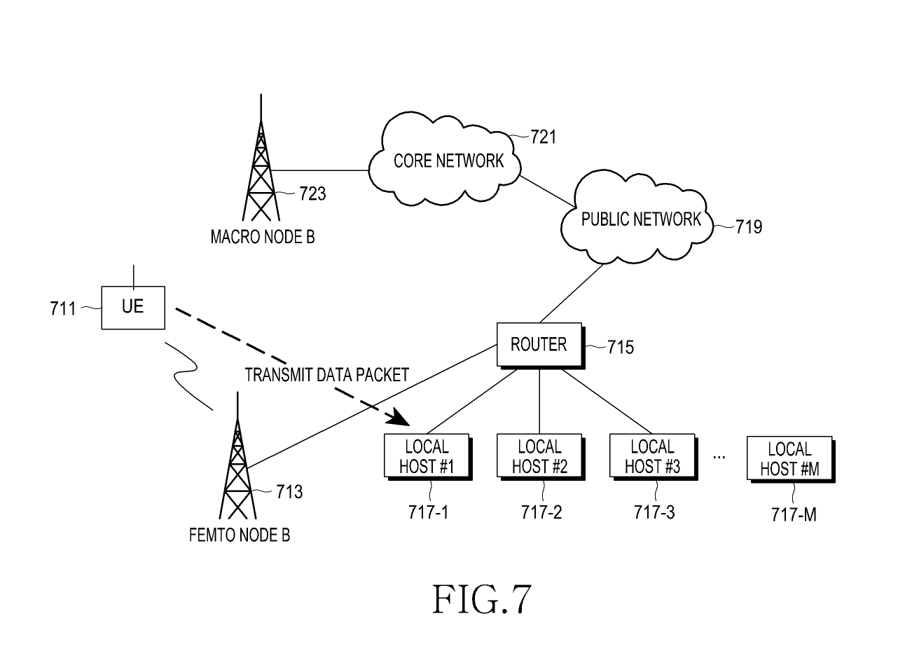

FIG. 7 schematically illustrates a process in which a UE connected to a femto Node B transmits a data packet to a local host in a WCDMA communication system in accordance with an exemplary embodiment of the present invention.

Referring to FIG. 7, a UE 711 connected to a femto Node B 713 converts an inner data packet into an outer data packet by performing an encapsulation process if a data packet targeting a local host #1 717-1 occurs, and transmits the outer data packet to a router 715 through the femto Node B 713.

That is, if the data packet targeting the local host #1 717-1 occurs, the UE 711 converts the data packet targeting the local host #1 717-1, i.e., the inner data packet into the outer data packet by performing the encapsulation process, and the detailed description will be followed.

The UE 711 generates the inner data packet by setting a field value of an inner source IP address included in an inner IP header field as a GGSN IP address of the UE 711, setting a field value of an inner destination IP address as a local IP address of the local host #1 717-1, and setting a field value of an inner payload as data including data which the UE 711 wants to transmit to the local host #1 717-1.

The UE 711 converts the inner data packet into the outer data packet by performing the encapsulation process. That is, the UE 711 generates the outer data packet by setting a field value of an outer destination IP address as a public IP address of the router 715, setting a field value of an outer source IP address as the GGSN IP address of the UE 711, setting a field value of a port field as a global data plan port, and setting a field value of an outer payload field as equal to the inner data packet.

The UE 711 transmits the outer data packet which is generated using the encapsulation process to the router 715. The router 715 converts a field value of the outer destination IP address field and a field value of the port field into a local IP address of the Node B 713 and a local data plan port respectively using a port forward function, and transmits an outer data packet with the outer destination IP address field of which the field value is the a local IP address of the Node B 713, and the port field of which the field value is the local data plan port to the femto Node B 713.

The femto Node B 713 converts the outer data packet into an inner data packet by performing a decapsulation process because the field value of the port field included in the outer data packet received from the router 715 is the local data plan port. That is, since the field value of the port field included in the outer data packet received from the router 715 is the local data plan port, the femto Node B 713 generates an inner data packet by setting a field value of an inner source IP address included in a payload field included in the outer data packet as a local IP address mapped to a GGSN IP address of the UE 711 in a LIPA table which the femto Node B 713 manages.

The femto Node B 713 transmits the inner data packet which is generated using the decapsulation process to the local host #1 717-1.

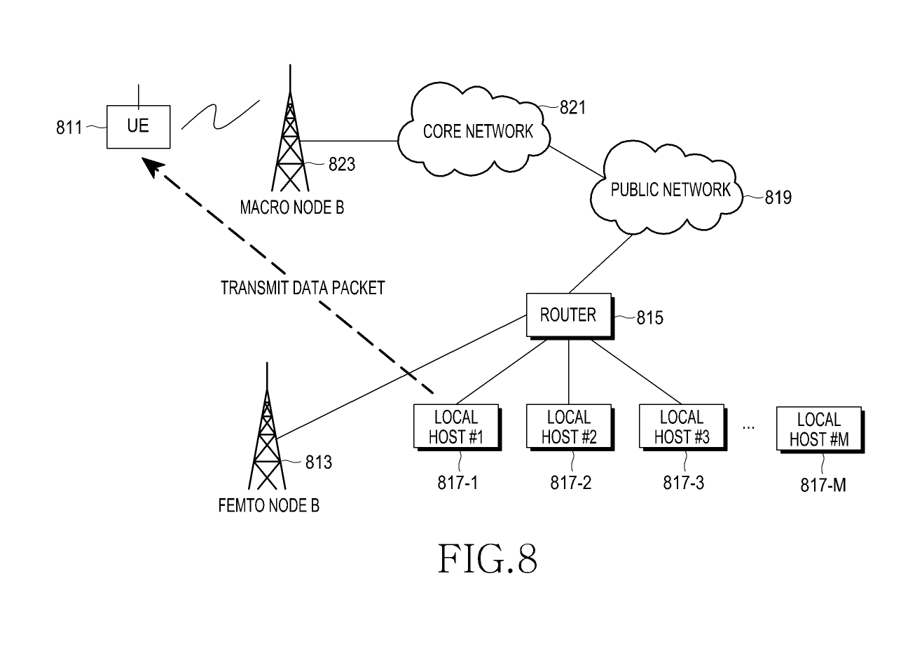

FIG. 8 schematically illustrates a process in which a local host transmits a data packet to a UE connected to a macro Node B in a WCDMA communication system in accordance with an exemplary embodiment of the present invention.

Referring to FIG. 8, if a data packet targeting a UE 811 connected to a macro Node B 823 occurs, a local host #1 817-1 transmits the data packet to a femto Node B 813 through a router 815. The data packet transmitted from the local host #1 817-1 to the router 815 is an inner data packet, a field value of an inner source IP address field included in the inner data packet is set as a local IP address of the local host #1 817-1, for example, 192.168.10.100, and a field value of an inner destination IP address field included in the inner data packet is set as a local IP address of the UE 811, for example, 192.168.10.200.

The femto Node B 813 detects a GGSN IP address of the UE 811, for example, 10.10.10.10 from a LIPA table using a destination IP address included in an inner data packet received from the local host #1 817-1. The femto Node B 813 changes the destination IP address included in the inner data packet to the detected GGSN IP address of the UE 811. The femto Node B 813 converts the inner data packet into an outer data packet by performing an encapsulation process, and transmits the outer data packet to a router 815. That is, the femto Node B 813 generates the outer data packet by performing the encapsulation process on the inner data packet received from the router 815, and the detailed description will be followed. In the encapsulation process, the femto Node B 813 generates the outer data packet by setting a field value of an outer source IP address field as a local IP address of the femto Node B 813, for example, 192.168.10.220, setting a field value of an outer destination IP address field as the GGSN IP address of the UE 811, for example, 10.10.10.10, setting a field value of a port field as a local data plan port, and setting a field value of an outer payload field as equal to the inner data packet.

The femto Node B 813 transmits the generated outer data packet to the router 815. The router 815 changes a field value of the outer source IP address field and a field value of the port field to a public IP address of the router 815, for example, 175.1.2.165, and a global data plan port respectively using a port forward function, and transmits the outer data packet of which the outer source IP address field has the field value changed to the public IP address of the router 815, and the port field has the field value changed to the global data plan port to the UE 811 through a public network 819, a core network 821, and a macro Node B 823.

The UE 811 generates an inner data packet by performing a decapsulation process on the received outer data packet because a field value of an outer source IP address field included in the outer data packet received from the macro Node B 823 is a public IP address of the router 815, and a field value of a port field is a global data plan port. So, the UE 811 receives data packet transmitted from the local host #1 817-1.

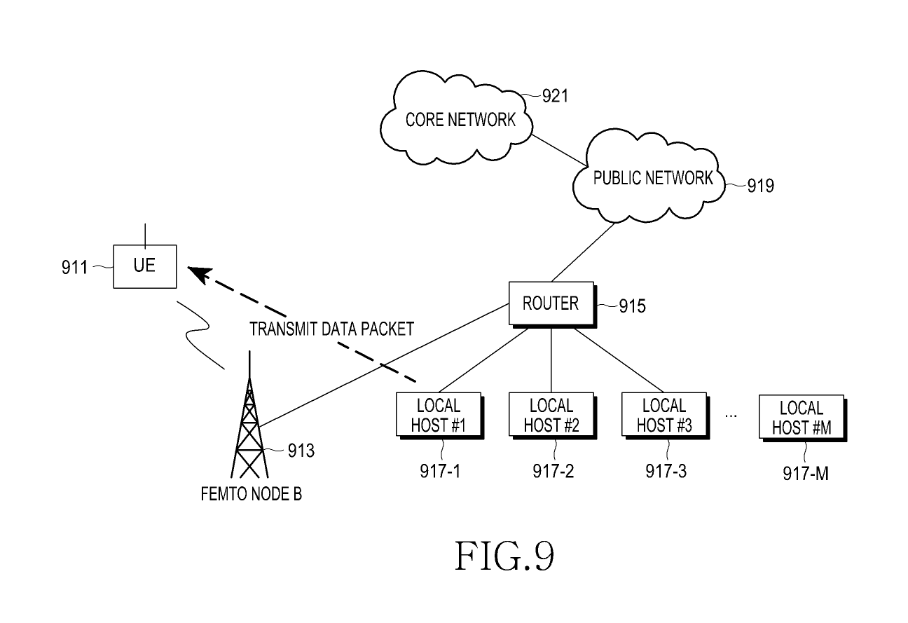

FIG. 9 schematically illustrates a process in which a local host transmits a data packet to a UE connected to a femto Node B in a WCDMA communication system in accordance with an exemplary embodiment of the present invention.

Referring to FIG. 9, if a data packet targeting a UE 911 connected to a femto Node B 813 occurs, a local host #1 917-1 transmits the data packet to a femto Node B 913 through a router 915. The data packet transmitted from the local host #1 917-1 to the router 915 is an inner data packet, a field value of an inner source IP address field included in the inner data packet is set as a local IP address of the local host #1 917-1, for example, 192.168.10.100, and a field value of an inner destination IP address field included in the inner data packet is set as a local IP address of the UE 911, for example, 192.168.10.200.

The femto Node B 913 changes a destination IP address included in an inner data packet received from the router 915 to a GGSN IP address mapped to a LIPA table managed by the femto Node B 913, for example, 10.10.10.10 if the destination IP address is a local IP address, of a UE, mapped to the LIPA table. The femto Node B 913 generates an outer data packet by performing an encapsulation process on the inner data packet of which the destination IP address is changed, and transmits the generated outer data packet to the UE 911. That is, the femto Node B 913 generates the outer data packet by performing the encapsulation process on the inner data packet received from the router 915, and the detailed description will be followed.

The femto Node B 913 generates the outer data packet by setting a field value of an outer source IP address field as a public IP address of the router 915, for example, 175.1.2.165, setting a field value of an outer destination IP address field as a GGSN IP address of the UE 911, for example, 10.10.10.101, setting a field value of a port field as a global data plan port, and setting a field value of an outer payload field as equal to the inner data packet.

The femto Node B 913 transmits the generated outer data packet to the UE 911. The UE 911 generates an inner data packet by performing a decapsulation process on the outer data packet received from the femto Node B 913 because a field value of an outer source IP address field is a public IP address of the router 915, and a field value of a port field is a global data plan port. So, the UE 911 receives a data packet transmitted from the local host #1 917-1.

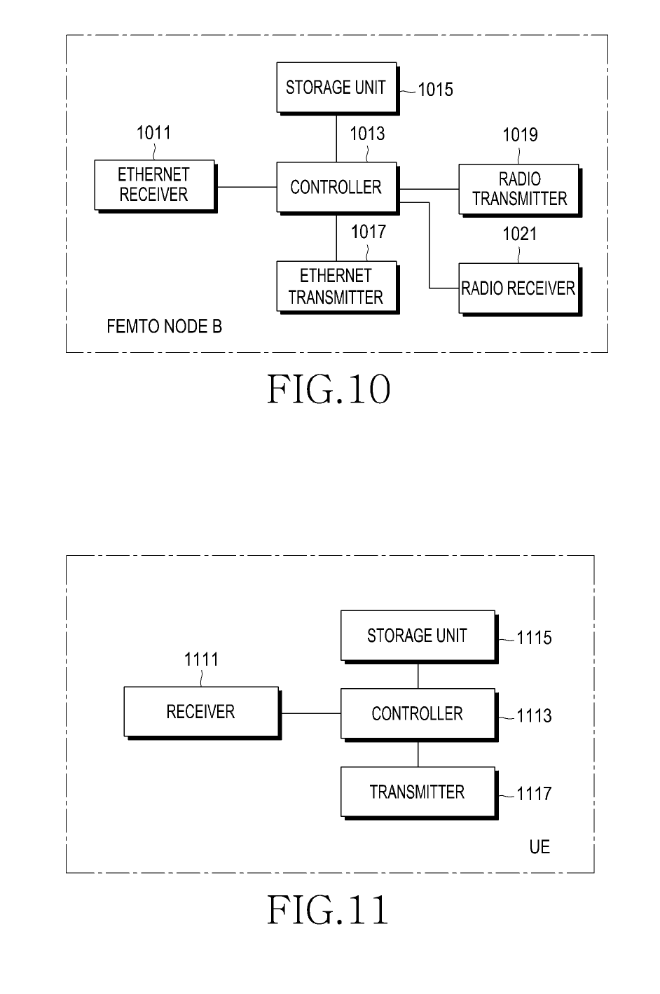

FIG. 10 is a block diagram schematically illustrating an internal structure of a femto Node B in a WCDMA communication system in accordance with an exemplary embodiment of the present invention.

Referring to FIG. 10, a femto Node B includes an Ethernet receiver 1011, a controller 1013, a storage unit 1015, an Ethernet transmitter 1017, a radio transmitter 1019 and a radio receiver 1021. The controller 1013 controls the overall operation of the femto Node B, specially controls the femto Node B to perform a process for setting up a radio bearer with a UE, an encapsulation process for converting an inner data packet into an outer data packet, and a decapsulation process for converting an outer data packet into an inner data packet. The process for setting up the radio bearer with the UE, the encapsulation process and the decapsulation process are performed in the manner described before with reference to FIGS. 2 to 9, so the detailed description will be omitted herein.

The Ethernet receiver 1011 is connected to a router through an Ethernet, and receives messages from the router under a control of the controller 1013. Since the femto Node B is connected to the router through the Ethernet, the femto Node B includes the Ethernet receiver 1011, however, it will be understood by those of ordinary skill in the art that the Ethernet receiver 1011 may be changed to an arbitrary receiver for processing an interface different from the Ethernet if the femto Node B is connected to the router through the interface different from the Ethernet.

The Ethernet transmitter 1017 is connected to a router through the Ethernet, and transmits messages to the router under the control of the controller 1013. Since the femto Node B is connected to the router through the Ethernet, the femto Node B includes the Ethernet transmitter 1017, however, it will be understood by those of ordinary skill in the art that the Ethernet transmitter 1017 may be changed to an arbitrary transmitter for processing an interface different from the Ethernet if the femto Node B is connected to the router through the interface different from the Ethernet.

The radio transmitter 1019 transmits messages, a radio bearer setup request packet, an inner data packet and an outer data packet to a UE under the control of the controller 1013. The radio receiver 1021 receives messages, a radio bearer setup request packet, an inner data packet and an outer data packet from the UE under the control of the controller 1013. The storage unit 1015 stores information such as the received messages, radio bearer setup request packet, inner data packet and outer data packet.

While the Ethernet receiver 1011, the controller 1013, the storage unit 1015, the Ethernet transmitter 1017, the radio transmitter 1019 and the radio receiver 1021 are shown in FIG. 10 as separate units, it is to be understood that this is for merely convenience of description. In other words, the Ethernet receiver 1011, the controller 1013, the storage unit 1015, the Ethernet transmitter 1017, the radio transmitter 1019 and the radio receiver 1021 may be incorporated into a single unit.

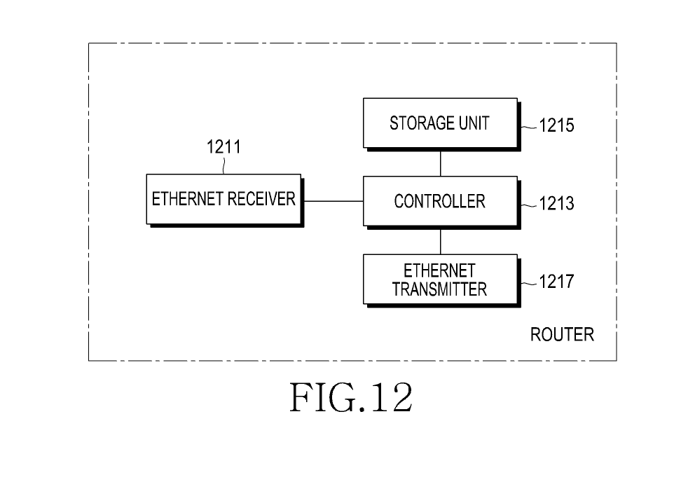

FIG. 11 is a block diagram schematically illustrating an internal structure of a UE in a WCDMA communication system in accordance with an exemplary embodiment of the present invention.

Referring to FIG. 11, a UE includes a receiver 1111, a controller 1113, a storage unit 1115 and a transmitter 1117. The controller 1113 controls the overall operation of the UE, specially controls the UE to perform a process for setting up a radio bearer with a femto Node B, an encapsulation process for converting an inner data packet into an outer data packet, and a decapsulation process for converting an outer data packet into an inner data packet. The process for setting up the radio bearer with the femto Node B, the encapsulation process and the decapsulation process are performed in the manner described before with reference to FIGS. 2 to 9, so the detailed description will be omitted herein.

The receiver 1111 receives messages, a radio bearer setup request packet, an inner data packet and an outer data packet from the femto Node B under the control of the controller 1113. The storage unit 1115 stores the received messages, radio bearer setup request packet, inner data packet and outer data packet. The transmitter 1117 transmits messages, a radio bearer setup request packet, an inner data packet and an outer data packet to the femto Node B under the control of the controller 1113.

While the receiver 1111, the controller 1113, the storage unit 1115 and the transmitter 1117 are shown in FIG. 11 as separate units, it is to be understood that this is for merely convenience of description. In other words, the receiver 1111, the controller 1113, the storage unit 1115 and the transmitter 1117 may be incorporated into a single unit.

FIG. 12 is a block diagram schematically illustrating an internal structure of a router in a WCDMA communication system in accordance with an exemplary embodiment of the present invention.

Referring to FIG. 12, a router includes an Ethernet receiver 1211, a controller 1213, a storage unit 1215 and an Ethernet transmitter 1217. The controller 1213 controls the overall operation of the router, specially controls the router to perform a port forward function. The port forward function is performed in the manner described before with reference to FIGS. 2 to 9, so the detailed description will be omitted herein.

The Ethernet receiver 1211 is connected to a femto Node B through an Ethernet, and receives messages, an inner data packet and an outer data packet from the femto Node B under a control of the controller 1213. Since the router is connected to the femto Node B through the Ethernet, the router includes the Ethernet receiver 1211, however, it will be understood by those of ordinary skill in the art that the Ethernet receiver 1211 may be changed to an arbitrary receiver for processing an interface different from the Ethernet if the router is connected to the femto Node B through the interface different from the Ethernet.

The storage unit 1215 stores the received messages, inner data packet and outer data packet.

The Ethernet transmitter 1217 is connected to the femto Node B through the Ethernet, and transmits messages, an inner data packet and an outer data packet to the femto Node B under the control of the controller 1213. Since the router is connected to the femto Node B through the Ethernet, the router includes the Ethernet transmitter 1217, however, it will be understood by those of ordinary skill in the art that the Ethernet transmitter 1217 may be changed to an arbitrary transmitter for processing an interface different from the Ethernet if the router is connected to the femto Node B through the interface different from the Ethernet.

While the Ethernet receiver 1211, the controller 1213, the storage unit 1215 and the Ethernet transmitter 1217 are shown in FIG. 12 as separate units, it is to be understood that this is for merely convenience of description. In other words, the Ethernet receiver 1211, the controller 1213, the storage unit 1215 and the Ethernet transmitter 1217 may be incorporated into a single unit.

As is apparent from the foregoing description, exemplary embodiments of the present invention enable accessing a local network regardless of a location of a UE in a mobile communication supporting a LIPA scheme.

In addition, exemplary embodiments of the present invention enable automatically selecting a network path based on a location of a UE in a mobile communication supporting a LIPA scheme.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for accessing a local network by a User Equipment (UE) in a mobile communication system supporting a Local network Internet Protocol Access (LIPA) scheme, comprising:
if a data packet targeting a local host occurs, converting the first inner data packet into the first outer data packet by performing an encapsulation process; and
transmitting the first outer data packet to a femto Node B through a router thereby the femto Node B converts the second outer data packet into the second inner data packet by performing a decapsulation process, and transmits the second inner data packet to the local host,
wherein each of the first inner data packet and the second inner data packet is a data packet used in a local network, each of the first outer data packet and the second outer data packet is a data packet used in an outer network, and the second outer data packet is an outer data packet into which the router converts the first outer data packet using a port forward function.

2. The method as claimed in claim 1, wherein each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

3. A method for supporting an access to a local network of a User Equipment (UE) by a femto Node B in a mobile communication system supporting a Local network Internet Protocol Access (LIPA) scheme, comprising:
receiving the second outer data packet into which a router has converted the first outer data packet using a port forward function from the router;
converting the second outer data packet into the first inner data packet by performing a decapsulation process; and
transmitting the first inner data packet to a local host,
wherein the first outer data packet is generated by performing an encapsulation process on the second inner data packet which is generated if a data packet targeting the UE occurs, each of the first inner data packet and the second inner data packet is a data packet used in a local network, and each of the first outer data packet and the second outer data packet is a data packet used in an outer network.

4. The method as claimed in claim 3, wherein each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

5. A method for accessing a local network by a User Equipment (UE) in a mobile communication system supporting a Local network Internet Protocol Access (LIPA) scheme, comprising:
receiving the second outer data packet into which a router has converted the first outer data packet received from a femto Node B using a port forward function from the router; and
converting the second outer data packet into the first inner data packet by performing a decapsulation process,
wherein the first outer data packet is generated by the femto Node B by performing an encapsulation process on the second inner data packet which is generated if a data packet targeting the UE occurs at a local host, each of the first inner data packet and the second inner data packet is a data packet used in the local network, and each of the first outer data packet and the second outer data packet is a data packet used in an outer network.

6. The method as claimed in claim 5, wherein each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

7. A method for supporting an access to a local network of a User Equipment (UE) by a femto Node B in a mobile communication system supporting a Local network Internet Protocol Access (LIPA) scheme, comprising:
receiving the second outer data packet into which a router has converted the first outer data packet using a port forward function from the router;
converting the second outer data packet into the first inner data packet by performing a decapsulation process; and
transmitting the first inner data packet to a UE,
wherein the first outer data packet is generated by the femto Node B by performing an encapsulation process on the second inner data packet which is generated if a data packet targeting the UE occurs at a local host, each of the first inner data packet and the second inner data packet is a data packet used in the local network, and each of the first outer data packet and the second outer data packet is a data packet used in an outer network.

8. The method as claimed in claim 7, wherein each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

9. A method for accessing a local network by a User Equipment (UE) in a mobile communication system supporting a Local network Internet Protocol Access (LIPA) scheme, comprising:
receiving an outer data packet which a router receives from a femto Node B from the router; and
converting the outer data packet into the first inner data packet by performing a decapsulation process,
wherein the outer data packet is generated by the femto Node B by performing an encapsulation process on the second inner data packet which is generated if a data packet targeting the UE occurs at a local host, each of the first inner data packet and the second inner data packet is a data packet used in a local network, and the outer data packet is a data packet used in an outer network.

10. The method as claimed in claim 9, wherein each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and the outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

11. A method for supporting an access to a local network of a User Equipment (UE) by a femto Node B in a mobile communication system supporting a Local network Internet Protocol Access (LIPA) scheme, comprising:
receiving an outer data packet from a router;
converting the outer data packet into the first inner data packet by performing a decapsulation process; and
transmitting the first inner data packet to a UE,
wherein the outer data packet is generated by the femto Node B by performing an encapsulation process on the second inner data packet which is generated if a data packet targeting the UE occurs at a local host, each of the first inner data packet and the second inner data packet is a data packet used in a local network, and the outer data packet is a data packet used in an outer network.

12. The method as claimed in claim 11, wherein each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and the outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

13. A User Equipment (UE) in a mobile communication system supporting a Local network Internet Protocol Access (LIPA) scheme, comprising:
a controller for converting the first inner data packet into the first outer data packet by performing an encapsulation process if a data packet targeting a local host occurs; and
a transmitter for transmitting the first outer data packet to a femto Node B through a router thereby the femto Node B converts the second outer data packet into the second inner data packet by performing a decapsulation process, and transmits the second inner data packet to the local host,
wherein each of the first inner data packet and the second inner data packet is a data packet used in a local network, each of the first outer data packet and the second outer data packet is a data packet used in an outer network, and the second outer data packet is an outer data packet into which the router converts the first outer data packet using a port forward function.

14. The UE as claimed in claim 13, wherein each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

15. A femto Node B in a mobile communication system supporting a Local network Internet Protocol Access (LIPA) scheme, comprising:
a receiver for receiving the second outer data packet into which a router has converted the first outer data packet using a port forward function from the router;
a controller for converting the second outer data packet into the first inner data packet by performing a decapsulation process; and
a transmitter for transmitting the first inner data packet to a local host,
wherein the first outer data packet is generated by performing an encapsulation process on the second inner data packet which is generated if a data packet targeting the UE occurs, each of the first inner data packet and the second inner data packet is a data packet used in a local network, and each of the first outer data packet and the second outer data packet is a data packet used in an outer network.

16. The femto Node B as claimed in claim 15, wherein each of the first inner data packet and the second inner data packet includes an inner source Internet Protocol (IP) address field with a field value set as an IP address, of a source entity, used in the local network and an inner IP header field including an inner destination IP address field with a field value set as an IP address, of a destination entity, used in the local network, and each of the first outer data packet and the second outer data packet includes an outer source IP address field with a field value set as an IP address, of a source entity, used in the outer network, an outer IP header field including an outer destination IP address field with a field value set as an IP address, of a destination entity, used in the outer network, a Transmission Control Protocol (TCP) header field including a port field with a field value set as one of a global data plan port and a local data plan port, and an outer payload equal to the first inner data packet.

17. A User Equipment (UE) in a mobile communication system supporting a Local network Internet Protocol Access (LIPA) scheme, comprising:
a receiver for receiving the second outer data packet into which a router has converted the first outer data packet received from a femto Node B using a port forward function from the router; and
a controller for converting the second outer data packet into the first inner data packet by performing a decapsulation process,
wherein the first outer data packet is generated by the femto Node B by performing an encapsulation process on the second inner data packet which is generated if a data packet targeting the UE occurs at a local host, each of the first inner data packet and the second inner data packet is a data packet used in the local network, and each of the first outer data packet and the second outer data packet is a data packet used in an outer network.

18. A femto Node B in a mobile communication system supporting a Local network Internet Protocol Access (LIPA) scheme, comprising:
a receiver for receiving the second outer data packet into which a router ha converted the first outer data packet using a port forward function from the router;
a controller for converting the second outer data packet into the first inner data packet by performing a decapsulation process; and
a transmitter for transmitting the first inner data packet to a User Equipment (UE),
wherein the first outer data packet is generated by the femto Node B by performing an encapsulation process on the second inner data packet which is generated if a data packet targeting the UE occurs at a local host, each of the first inner data packet and the second inner data packet is a data packet used in a local network, and each of the first outer data packet and the second outer data packet is a data packet used in an outer network.

19. A User Equipment (UE) in a mobile communication system supporting a Local network Internet Protocol Access (LIPA) scheme, comprising:
a receiver for receiving an outer data packet which a router receives from a femto Node B from the router; and
a controller for converting the outer data packet into the first inner data packet by performing a decapsulation process,
wherein the first outer data packet is generated by the femto Node B by performing an encapsulation process on the second inner data packet which is generated if a data packet targeting the UE occurs at a local host, each of the first inner data packet and the second inner data packet is a data packet used in a local network, and the outer data packet is a data packet used in an outer network.

20. A femto Node B in a mobile communication system supporting a Local network Internet Protocol Access (LIPA) scheme, comprising:
a receiver for receiving an outer data packet from a router;
a controller for converting the outer data packet into the first inner data packet by performing a decapsulation process; and
a transmitter for transmitting the first inner data packet to a UE,
wherein the first outer data packet is generated by the femto Node B by performing an encapsulation process on the second inner data packet which is generated if a data packet targeting the UE occurs at a local host, each of the first inner data packet and the second inner data packet is a data packet used in a local network, and the outer data packet is a data packet used in an outer network.
